(19) United States
(12) Patent Application Publication
(10) Pub. No.: US 2009/0050620 A1
(43) Pub. Date: Feb. 26, 2009

(54) CONTACT HEATING ARRANGEMENT

(75) Inventors: Per Andersson, Uppsala (SE); Gunnar Kylberg, Bromma (SE)

Correspondence Address: FULBRIGHT & JAWORSKI, LLP, 1301 MCKINNEY, SUITE 5100, HOUSTON, TX, 77010-3095, US

(73) Assignee: GYROS AB, Uppsala (SE)

(21) Appl. No.: 10/585,442

(22) PCT Filed: Jan. 5, 2005
(86) PCT No.: PCT/SE2005/000005

§ 371 Date: Oct. 28, 2008

Related U.S. Application Data
(60) Provisional application No. 60/534,830, filed on Jan. 7, 2004.

(30) Foreign Application Priority Data
Jan. 6, 2004 (SE) 0400006-3

(51) Int. Cl. B01L 7/00; B04B 15/02

(52) U.S. Cl. 219/430; 435/288.4; 219/431; 219/432; 494/13; 219/521; 219/526

(57) ABSTRACT

A heating arrangement for heating one or more liquid-containing microcavities (102) that are present on a microdevice (101) in which there is a contact surface (S_{dev}) (108). The arrangement comprises a heating support (104,204) that has:
a) a support contact surface (Sₛᵤₚ) (110) which is apposed to S_{dev} (108), when the microdevice (101) is placed on the heating support (104,204), and
b) one or more heating elements (120,220) each of which are in thermal contact with Sₛᵤₚ (110), and also with at least one of said microcavities (102), when the microdevice (101) is placed according to (a) with said microcavities (102) matched to said heating elements (120,220),
   The characteristic feature of the arrangement is that it comprises a sub pressure system (113-119) that is capable of creating sub pressure between said support (104,204) and said microdevice (101) via the support when the microdevice (101) is placed on the support (104,204).

### CROSS-REFERENCE TO RELATED APPLICATIONS

This application is the National Stage Application of International Application No. PCT/SE2005/000005 filed Jan. 5, 2005 which claims priority to Swedish Application No. SE 0400006-3 filed Jan. 6, 2004 and U.S. Provisional Application No. 60/534,830 filed Jan. 7, 2004.

### TECHNICAL FIELD

The present invention relates to an arrangement and/or a method for locally heating liquid that is present in one, two, three or more microcavities of a microdevice. The invention also concerns a method for performing a process protocol comprising a step in which a liquid aliquot is processed at an elevated temperature in a microcavity, possibly with a subsequent step in which the temperature has been lowered or further increased.

### BACKGROUND TECHNOLOGY

It has been suggested that a heating element that shall be used for heating a liquid aliquot that is present in a microcavity of microdevice should be placed within the device and in close proximity of the microcavity. Such heating elements have utilized electrical heating, absorption of irradiation and other means. See for instance WO 9322058 (Univ. of Penn.) and WO 0146465 (Gyros AB), WO 0241997 (Gyros AB) and WO 0241998 (Gyros AB). It has also been suggested to place the heating elements on a separate device (heating support) that during heating is in thermal contact with the microdevice and the microcavities to be heated. See for instance WO 0078455 (Gamera/Tecan). Cooling of a liquid aliquot after a reaction step that has been performed at an elevated temperature (=high temp step) has been accomplished by dissipating heat internally within the device and/or to ambient atmosphere. Transfer of heat to ambient atmosphere has been favoured by permitting a cooling air stream to pass over the surfaces of the microdevice, for instance by spinning the device, by directing compressed air at the surfaces of the device etc.

Heating elements that are present in a microdevice in close proximity to the object to be heated are known to be highly efficient but the manufacturing costs are unacceptable if the microdevice is to be used as a disposable. One alternative would be a separate heating support that is placed in direct contact with the device during heating. See for instance WO 0078455 (Gamera/Tecan). This solution increases the risk for inefficient heat transfer, e.g. a separate heating support in many instances will imply heating of larger masses and volumes than if the heating elements were on the same device as the microcavity. In other word a separate heating support will counteract a desire of fast cooling of an warm liquified. Process protocols that comprise a thermocycling step may become problematic. Improvements are desired for the heating of minute volumes of liquid in microdevices.

In order to accomplish efficient local heating of microcavities in a microdevice it is important with:
a) even heating and/or even cooling with insignificant temperature gradients across the liquid aliquot that is present in a microcavity,
b) low intercavity variations in heating,
c) low undesired heat transport between neighboring microcavities,
d) minimizing heating of the bulk material of the microdevice (typically between microcavities),
e) avoiding increasing the temperature of ambient atmosphere etc.

Several of these principles are particularly important if the process protocol comprises thermocycling, for instance with two or more heating-cooling cycles. Problems associated with these principles often are more accentuated the smaller the volumes are, for instance when going down within the μl-format such as into the nl-format. Problems easily become more severe when increasing the dense-packing of the microcavities on a microdevice.

The objects of the present invention relate to improvements of the various aspects of the invention. More particularly the improvements concerns minimizing the problems discussed above and/or facilitating implementation of the principles discussed above.

### SUMMARY OF THE INVENTION

The first aspect of the invention is an arrangement for heating one or more liquid aliquots, each of which is present in a microcavity (102) of a microdevice (101) containing one, two, three or more microcavities (102). The microdevice (101) may be part of the heating arrangement in certain embodiments.

In its broadest sense the characteristic feature of the arrangement is that it comprises:
a) a separate heating support (104) that has one side (contact side) (111) that comprises a contact surface (Sₛᵤₚ) (110, support contact surface),
b) a microdevice (101) that contains
   the microcavities (102) in which the liquid aliquots to be heated may be present, and
   a contact surface (S_{dev}) (108, device contact surface) that is apposed to Sₛᵤₚ (110) when the microdevice (101) is properly placed on the heating support (104).
c) a sub pressure system (113-119) that provides reduced pressure to the contact side (111) with preference for Sₛᵤₚ (110), of the heating support (104) for retaining the microdevice (101) via S_{dev} (108) to Sₛᵤₚ (110).

The heating support (104) typically comprises a heating system (120-124), e.g. comprising one or more heating elements (120a,b . . . ) that match the microcavities (102) of a microdevice (101) that is properly placed on the heating support. The terms “match” and “properly placed” in this context shall mean that, when the microdevice (101) is retained on the contact side (111) of the heating support (104) and the heating elements (120a,b . . . ) heated, heat is transferred from the heating support (104) to the microdevice (101) and to a liquid aliquot that possibly is present in a microcavity (102) of the microdevice (101). Transfer of heat is primarily from Sₛᵤₚ (110) to S_{dev} (108). This includes that the microcavity (102) may be heated before the liquid aliquot is placed in the microcavity.

The sub pressure system (113-119) creates reduced pressure in a sub pressure space (118,119) between the heating support (104) and the microdevice (101), preferably between the support contact surface Sₛᵤₚ (110) and the device contact surface S_{dev} (108).

The other main aspects of the invention utilize this kind of arrangement and relate among others to methods of heating and methods of performing protocols comprising a heating step.

The microcavities (102) of the microdevice (101) are distributed within the microdevice across the contact surface S_{dev} (108). One or more up to all of the microcavities (102) are preferably at the same distance from the device contact surface S_{dev} (108). In certain variants the microdevice may contain groups of microcavities for which the distance between a microcavity and the device contact surface S_{dev} (108) is the same for the microcavities of a group but different for different groups. A group of microcavities contains one, two or more microcavities.

The support contact surface Sₛᵤₚ (110) and the device contact surface S_{dev} (108) typically have the same size and form and are in thermal contact with each other when the microdevice (101) is placed on the heating support (104).

Sₛᵤₚ (110) typically coincides with the actual contact side (111) of the support. S_{dev} (108) typically coincides with the actual contact side (109) of the microdevice (101).

Each microcavity (102) is associated with a thermal contact area (125 plus 126) that is the volume between and a heating element (120) and a microcavity (102) that is properly placed on a heating support (104). See FIG. 1b. Properly placed includes that the microcavity covers at least a part of one or more heating elements (juxta-positioning of the microcavity and the heating elements in relation to each other). The part (125) of a thermal contact area that is present on the microdevice (101) is defined as the portion (volume) of the microdevice (101) that is covered by the microcavity (102) and stretches from the microcavity to the device contact surface S_{dev} (108). The remaining part (126), if any, of the thermal contact area is present on the heating support (104) and is defined as the portion (volume) of the heating support (104) that is covered by the microcavity (102) and stretches from the support contact surface Sₛᵤₚ (110) to a heating element (120). A microcavity (102) may cover heating elements that are at different distances from Sₛᵤₚ (110) or there may be parts (127) (FIG. 1b) of the microcavity/thermal contact area that are not covering any heating element (120). In these cases the thermal contact area (126) stretches down to the level of the heating element (120) that is farthest away from Sₛᵤₚ (110). Compare patterned heating below.

For a given heating support that is intended for microdevices that differ with respect to size, shape and distribution of their microcavities, the thermal contact area will vary depending on which particular microdevice is used at the moment.

### BRIEF DESCRIPTION OF THE DRAWINGS

FIG. 1a illustrates a variant of the innovative arrangement in which a circular heating support of the type shown in FIG. 2 and a circular microdevice are placed on rotary member (carrier) of a spinner. The view is through a plane going through the spin axis that is common with the axis of symmetry of the microdevice and the heating support. The plane is indicated by the lane A and A′ in FIG. 2.

FIG. 1b is an enlarged cross-sectional view of the encircled part in FIG. 1a.

FIG. 2 illustrates a circular transparent heating support having an axis of symmetry and annular heating elements. The support is the same as the support shown in FIG. 1.

FIG. 3 illustrates temperature gradients obtained in a simulated experiment. The view is a side view through the same plane as for FIG. 1a.

The first digit in the 3-digits reference numbers refers to the figure concerned. The other two digits refer to particular items. Corresponding items in different figures have reference numbers with the same two digits ending.

### DETAILED DESCRIPTION OF THE INVENTION

### Sub Pressure System

The sub pressure system typically comprise three main parts:
a) A system of shallow formations (recessed parts=recessions) (118,119) in the contact side (111) of the heating support (104) plus a channel system (117) within the heating support (104) for sub pressure communication between the shallow formations (118,119) and those parts (113-116) of the sub pressure system that normally are outside the heating support (104). The shallow formations are preferably present in the support contact surface Sₛᵤₚ (110). They may alternatively be present in the device contact side (109) and then in particular in the device contact surface S_{dev} (108)
b) A sub pressure source (113) that typically is external to the heating support (104).
c) Connections (114-116) between the sub pressure source (113) and the part of the sub pressure system that is present on the heating support (104). These connections may comprise a conduit system (116) that is present in a carrier (103) for the heating support (104) and is used for linking sub pressure to the heating support (104). This conduit system (116) in turn may be linked to the sub pressure source (113) via one or more external sub pressure conduits (114), such as tubes and or enclosed channels, for instance.

The recessed parts (118,119) of the sub pressure system form an enclosed sub pressure space (118,119) when the microdevice (101) is placed on the contact side (111) of the heating support (104). The recessed parts (118,119) should be designed to support essentially equal adhesion and/or thermal contact between the support contact surface Sₛᵤₚ (110) and the device contact surface S_{dev} (108) at each microcavity (102) to be heated.

Recessed parts (118,119) of the sub pressure system may include wells and/or indentations and/or impressions and/or uncovered grooves. A recessed part in the form of a well may have the shape of a circle, oval, nudel, bean, polygon etc. Typical polygons are triangles, rectangles, pentagons, hexagons etc. Recessed parts in the form of grooves and or otherwise elongated impressions or indentations may be straight, curved, arc-shaped, circular, angled etc.

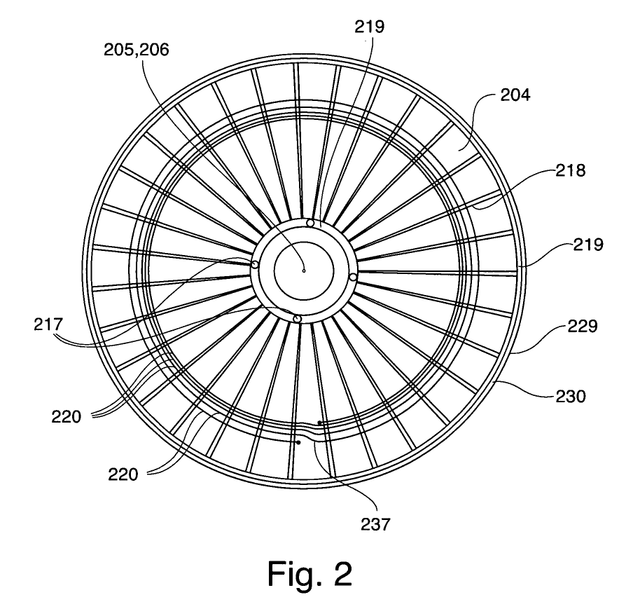

Recessed parts may be distributed in an organized or randomised pattern in one or both of the contact sides (109,111), typically in S_{dev} (108) and Sₛᵤₚ (110), respectively. The system of recessed parts may thus be a number of concentric annular grooves (119) and/or a number of straight grooves (118) that are parallel, angled etc relative to each other. A typical arrangement that may comprise straight grooves is the spike arrangement, which normally comprises one, two or more spikes (118) (radially directed grooves). In the spike arrangement the spikes may start at the center or at a distance from the center (106a). In the case of annular grooves (119) the number of grooves is typically one, two three, four or more. In the case both straight (118) and annular grooves (119) are present they may intersect each other, for instance in a spike arrangement there may be also one, two or more concentric annular grooves (119) with a center that coincides with the center of the spikes. Spike and annular arrangement include that the arrangement covers only a part of the full circle, i.e. also a sector of a spike arrangement. A spike arrangement is shown in FIG. 2.

Spike arrangement also comprises so-called evolvent spikes, i.e. arc-shaped spikes which are essentially parallel and directed from an inner position to an outer position relative to the center of the arrangement (=essentially radial direction).

Other kinds of recessions include surface textures, e.g. obtained by a grinding, blasting etc. Blasting in this context includes glass and sand blasting, for instance.

In preferred embodiments, a smooth portion (130,230) of S_{dev} (108) of the microdevice (101) and/or of Sₛᵤₚ (110) of the heating support (104) is devoid of sub pressure recessions and completely surrounds all the recessions (118,119) of the sub pressure system or a subset of such recessions. The presence of this kind of smooth portion will assist in securing an air-tight sealing-contact between the contact surface S_{dev} (108) of the microdevice (101) and the contact surface Sₛᵤₚ (110) of the heating support (104).

This kind of tightening portion may in certain preferred variants be paralleled with or contain a tightening resilient seal element that also encircles the recessed parts of the sub pressure system or a subset of such parts. Such a seal element is typically placed in a separate recession (seal element recession) that also encircles recessed parts of the sub pressure system. The depth and width of the seal element recession and the dimension of the seal element are matched to each other such that tight contact between the non-recessed parts of support surface Sₛᵤₚ (110) and the contact surface S_{dev} (108) of the microdevice can be accomplished. The seal element and the seal element recession are not shown in the drawings.

The depth of the recessed parts (118,119) of the sub pressure system is typically less than half of the thickness of the heating support. In most cases this means depths in the μm-range, i.e. ≦5,000 μm, such as ≦1,000 μm or ≦500 μm or ≦100 g/m or ≦50 μm. From practical manufacturing considerations the depth of discrete grooves and wells are typically ≧10 μm. The depth may vary between the recessions and/or within a recession.

Suitable distributions and designs of the recessed parts are given in WO 03025549 (Gyros AB) and WO 03024596 (Gyros AB).

Any kind of conventional sub pressure source can be used as long as it is capable of creating a sub pressure in the sub pressure system that is sufficient for retaining the microdevice to the support surface Sₛᵤₚ during the heating of a microdevice. This typically means ≦0.9 bar, such as ≦0.5 bar or ≦0.1 bar or ≦0.01 bar or ≦0.05 bar, e.g. in the interval 0.001 bar-0.950 bar. Pressure figures relate to absolute pressure.

The enclosed channel system within the heating support is relatively short.

### The Heating System

The heating support (104) comprises one or a plurality of heating element(s) (120) and typically one thermal contact area (126) for each microcavity (102) on a microdevice (101) placed on the support (104). Other parts are electrical connections (237) between the heating elements (120) and/or to an external voltage source.

The heating elements (120) are arranged such that every microcavity (102) to be heated of a microdevice (101) can be juxta-positioned over at least a part of one or more of the heating elements (120).

A heating element may be of the type that increases its temperature upon
a) irradiation, for instance by irradiation with visible light, UV, IR, radio waves, micro waves, electrons, y-radiation etc,
b) transportation of current through the element,
c) physically contacting the element with an external heat source for instance via a through-flowing heated liquid stream, such as hot water or hot air, and
d) carrying out an exothermal reaction.

In principle heating elements of the kinds that previously have been used for heating of liquid aliquots that are present within a microdevice can be used. See for instance WO 9322058 (Univ. of Penn.) and WO 0146465 (Gyros AB), WO 9853311 (Gamera Biosciences/Tecan), WO 0078455 (Gamera Biosciences/Tecan), WO 0241997 (Gyros AB) and WO 0241998 (Gyros AB).

The preferred heating elements at the filing date are selected amongst those in which heat is produced within the element, e.g. by i) a through-passing electrical current, or ii) absorption of irradiation.

Heating elements of type i) typically comprises an electrically conducting material of high resistivity. The heating elements may be connected to each other and/or to a voltage source via one or more connections that provide insignificant heat evolution compared to the heating elements, e.g. comprising an electrically conducting material of low resistivity. Connections between electrical heating elements (120) may be outside or within the heating support (104) depending among others on the design and/or positioning of the heating elements. Typical heating elements and their connections comprise some kind of wire (120a,b . . . , 122,237) of electrical conductive material. The heating elements and/or their connections may have been manufactured separate from the bulk of the heating support, for instance as separately manufactured wires of suitable dimensions, conductivities and resistivities. Alternatively the electrical heating elements are manufactured on the support during its manufacture, for instance by application of a conducting ink or powder with high resistivity for the heating elements and conducting ink or powder of low resistivity for the electrical connections/wires. Application of the ink/powder is typically by spraying, painting, printing, stamping and the like. Electrical heating elements of the ink/powder type may be combined with electrical connections of the prefabricated wire type or vice versa. The term “ink or powder” above and elsewhere in this specification includes paints and any other form of material that can be applied by the techniques given.

Electrical heating elements may be present in the support surface Sₛᵤₚ (110), enclosed within the body of the heating support (104), and/or most preferably in the side of the heating support (104) that is opposite to the support contact surface Sₛᵤₚ (110).

In the case heating elements are placed on a surface of the heating support, they may be placed directly on the surface of the support, e.g. on the contact surface Sₛᵤₚ or on the surface of the opposite side of the heating support. Heating elements that are located to a surface of the heating support are typically placed in recessions (121a,b . . . ) in the surface that completely or partly can contain the heating elements and/or their connections.

According to the other preferred heating principle a heating element is defined by incorporating a material that is capable of transforming an influx of irradiation to heat within the heating support. Typically the irradiation used interacts with this material, for instance by absorption of the irradiation, such as light. Potential candidates of irradiation are light of different types, such as infra red (IR), ultraviolet (UV), visible light etc, and microwaves, radiowaves, gamma-radiation, electron radiation etc. Light may be monochromatic, such as laser light, or broad band light. There are two main sub groups for defining this kind of heating elements:
1) The heating support comprises a material that interacts with the irradiation within delimited local areas (heating elements). Outside these areas there is essentially no such material and/or interaction. The local area will be heated selectively upon radiation.
2) The heating support comprises material that interacts with the irradiation on larger areas, for instance is manufactured from such a material. By directing irradiation only to limited local areas, only these local areas will be heated and function as heating elements in the invention. Irradiation of local areas can be accomplished by using the appropriate mask patterned with holes and place the mask between the irradiation source and the heating support, or by including appropriate other limitation means in the optics of the irradiation source or between the heating support and the irradiation source.

See for instance WO 0241997 (Gyros AB) and WO 0241998 (Gyros AB).

The material interacting with the intended irradiation may be incorporated into the heating support during its manufacture. This includes incorporation of the material as one or more distinct layers and/or local areas. The material may be applied as a surface layer in one or more local areas at the end of the manufacturing process. Useful techniques for applying surface layers includes printing, painting, spraying or stamping the material as an ink or powder at localized delimited areas or all over the support surface Sₛᵤₚ or in the same manner on the surface of the opposite side of the heating support. See for instance WO 0241997 (Gyros AB) and WO 0241998 (Gyros AB).

The beam path for irradiation is typically meeting the heating support (104) from the side opposite to the support surface Sₛᵤₚ (110). The irradiation may alternatively enter the heating support (104) through other sides, such as through sides that are angled relative to the side that is opposite to the support surface Sₛᵤₚ (110) (e.g. 90° (edge sides)) or through the side that comprises the support contact surface Sₛᵤₚ (110).

In certain variants the heating elements may be positioned such that the irradiation has to pass through the heating support and/or the microdevice before reaching the heating elements. In these variants it becomes important to adapt the bulk material in the heating support and/or in the microdevice to the irradiation such that heat evolution within other parts than in the heating element becomes insignificant.

Heating normally results in creation of significant temperature gradients across a microcavity (102) that is filled with a liquid. This means that there may be a significant difference in reaction rates in different parts of a microcavity (102). It is therefore often advantageous to arrange such that there is essentially no or a very flat temperature gradient in the X,Y-plane (i.e. a plane parallel to the contact surface S_{dev} (108) and Sₛᵤₚ (110)) and/or in the Y-plane (depth) of a microcavity (102) filled with liquid. The terms “essentially no” or “very flat temperature gradient” refer to the acceptable temperature variation for the process or reaction that is to take place with the microcavity during the time period the temperature is elevated. It is believed that for most processes and reactions, an acceptable temperature variation across a microcavity is at most 50%, such as most 25% or at most 10% or at most %, of the temperature difference across the thickness of a microfluidic device at the microcavity concerned. It is also believed that suitable temperature variations across the microcavity as such for most processes and reactions are within 10° C., such as within 5° C. or within 1° C. These variations (percentages as well as ° C.) apply to variations in the X,Y-plane and/or in the Z-direction (depth).

Temperature gradients that are close to zero or very flat can be accomplished by so called patterned heating of the individual microcavities (102). See WO 0241997 (Gyros AB) and WO 0241998 (Gyros AB). Patterned heating in the context of the present invention contemplates that the heating elements associated with a particular thermal contact area of the heating support are arranged to provide certain spots of lower elevated temperatures and other spots of higher elevated temperatures at the level of a heating element in a thermal contact area. By properly arranging the heating elements and/or the material in the thermal contact area, the spots with the higher temperature will take care of parts of a microcavity where there is a risk for a lower temperature and spots with the lower temperature will take care of the parts of the microcavity where there is a risk for a higher temperature. Electrical heating and heating by irradiation are particularly well-adapted for patterned heating of a microcavity.

In order to accomplish patterned heating there must be at least one heating element associated with each thermal contact area/microcavity (125,126/102), but preferably there are two or more separate heating elements associated with each thermal contact area.

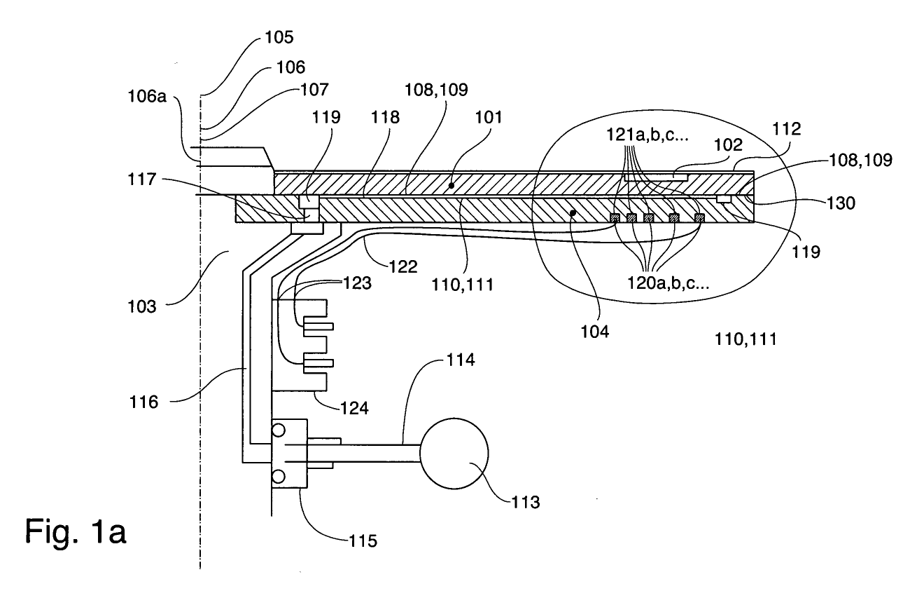

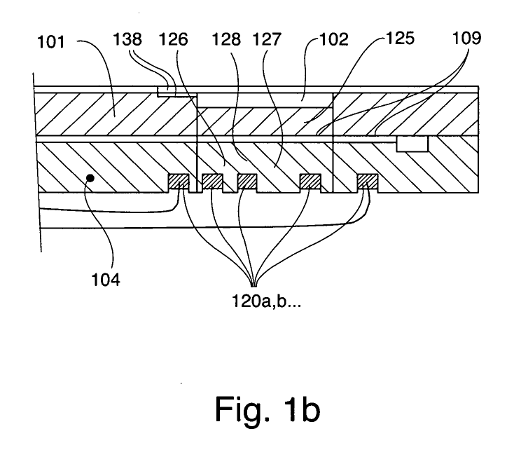

In one variant, patterned heating is accomplished with a thermal contact area/microcavity that in an X,Y-plane comprises one or more sections which each covers at least a part of a heating element and one or more other sections that cover no part of a heating element. Compare FIG. 1b in which the thermal contact area defined by the microcavity (102) has a part/section (128) that is located straight above a heating element (120c) and another part/section (127) that is located straight above the space between two neighboring heating elements (120c and d).

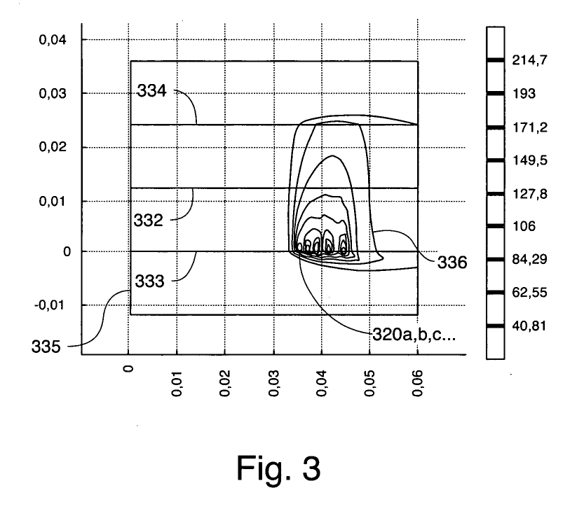

Patterned heating may thus be accomplished by associating a number of concentric circular heating elements of the same or different widths, or heating elements in the form of rounded spots, polygones etc with a microcavity. A rounded spot may be circular. Typical polygones are triangles, rectangles, etc. See FIGS. 3, 4, 5, 6, 7, and 8 in WO 0241998 (Gyros AB). A single heating element can be used for patterned heating in the case the heating element covers only a section of the thermal contact area (in the X,Y-plane) or is irregular in the sense that it twist back and forth into and out of the thermal contact area, for instance is coiled or serpentine-shaped.

Patterned heating may also be accomplished by incorporating material of different thermal conductivity in a thermal contact area (e.g. in the X,Y-plane). In this variant there is no imperative need for a section of the thermal contact area that covers no part of a heating element.

In another variant patterned heating is accomplished by the use of a heating element that have sections in which the heat evolution is different. An electrical heating element, for instance, may have parts that are associated with the same thermal contact area but have different specific resistivities.

In another variant of patterned heating, the heating support comprises channels, and/or cavities that crosses and/or are part of the thermal contact area of the heating support. These channels and cavities will induce variations in thermal transport in the thermal contact area and support patterned heating. In the case these channels or cavities are located in the support surface Sₛᵤₚ (110) they are in the form of uncovered recessions that are covered when the microdevice is placed for heating on the support. These channels or recesses may or may not be part of the sub pressure system.

### The Gross Design of the Heating Support

The heating support (104) typically is a plate and comprises
a) a heating function (120) as discussed above,
b) the shallow formations/recessions (118,119) in the contact side (111) of the heating support (104), with preference for the support surface Sₛᵤₚ (110) mentioned above, and
c) an enclosed channel system (117) connected to the sub pressure source (113) providing sub pressure to at least a portion of the shallow formations (118,119).

Alternatively the shallow formations/recessions may be present in the contact side (109) of the microdevice (101), in particular the device contact surface S_{dev} (108).

The support surface Sₛᵤₚ (110) is typically essentially flat except for the recessions (118,119) discussed above. One can envisage variants in which the support surface Sₛᵤₚ (110) is curved, for instance convex or concave, with the inverse curvature being present on the contact surface S_{dev} (108) of the microdevice (101) to be placed on the support surface Sₛᵤₚ (110). One can also envisage forms in which the support surface Sₛᵤₚ (110) provides projections with flat tops on which the contact surface S_{dev} (108) of the microdevice (101) is to rest. In this latter variant the space between the projections may correspond to the shallow formation of the sub pressure system. Alternatively the shallow formations that are connected to the sub pressure system are located in the top surface of the projections. The space/spaces between the projections will in both variants assist localized heating of the individual microcavities of a microdevice and facilitate rapid and efficient cooling after heating.

In variants where the support surface Sₛᵤₚ (110) comprises projections, each heating element is associated with at least one projection. When a microdevice is properly placed on such a heating support, each microcavity to be heated will be associated with a projection that is associated with a heating element. Such projections are thus part of the thermal contact areas of the heating support. The projections as such may comprise a heating element.

A heating support in the form of a plate is typically relatively thin in order to keep the heat storage capacity low. A low heat storage capacity is important in the case the process protocol carried out within a microdevice comprises heating followed by rapid cooling, e.g. thermocycling. The thickness (t) of the plate therefore should be ≧2d, such as ≧10d or ≧50d and ≦2000d, such as ≦1000d or ≦500d where d is the depth of the deepest of the recessions in the plate. Typically the heating support has a thickness selected in the interval of 0.1-10 mm depending on factors such as physical properties of the bulk material in the heating support.

The heating support, in particular if in the shape of a plate, typically comprises an axis of symmetry (Cₙ) (106) that is perpendicular to the contact side (111) comprising the support surface Sₛᵤₚ (110). n is an integer ≧2, such as 3 or 4 or 5 or 6 or larger, such as ≧8 or ≧10 including also circular forms (n=∞).

In preferred variants the heating support is retained on the rotary member (103) of a spinner arrangement for spinning the heating support. In preferred variants the spin axis (105) of the spinner arrangement coincides with the axis of symmetry (106) of the heating support (104). Spinning of the heating support (104) will assist rapid cooling of the heating support (104) and of a microdevice (101) placed on the support. Spinning will also assist in controlling the heating rate, in obtaining essentially the same temperature in all microcavities to be heated of a microdevice, in rendering over-heating more difficult etc. In variants based on spinning about a spin axis (105) that coincides with the axis of symmetry (106) of the heating support, n is preferably ≧6 with absolute preference for circular variants (n=∞).

In suitable spinner variants a rotary part (103) of the sub pressure system may be journalled for contact free or contact rotation relative to a stationary part of the sub pressure system. Sub pressure may then be communicated via a sealed and a non-sealed sub-pressure connection (115) between the surfaces of a rotary and a stationary member of the spinner arrangement. This includes various kinds. of swivel-designs (115).

Certain arrangements for linking sub pressure to a rotary part of a spinner are given in WO 03024596 (Gyros AB) and WO 03025549 (Gyros AB). Se also the experimental part of this specification.

The most advantageous bulk material in the heating support are plastics since plastics typically have a low heat storage capacity and low thermal conductivity which support local heating and cooling around the a local heating element. In the case electrical heating elements are to be incorporated conventional plastics has the further advantage of being essentially non-conductive for electricity.

The heating support is retained to a carrier (103) that typically comprises conduits (116, conduit system) for the sub pressure communication between the channel system (117) of the plate (104) (heating support) and the sub pressure source (113). In a preferred variant the carrier (103) is attached to the heating support (104) on the side that is opposite to the support surface Sₛᵤₚ (110). The area of contact between the carrier (103) and the heating support (104) should be relatively small compared to the cross-sectional area of the heating support (in a plane that is parallel to the support surface Sₛᵤₚ (X,Y-plane)). Typically this contact area is ≦50%, such as ≦25% or ≦10% of the area of the support surface Sₛᵤₚ (110) and/or the contact side (111). The smaller this ratio is the simpler will it be to cool down the heated parts, i.e. the heating support (104) and the microdevice (101). This is particularly important if the protocol performed within the microdevice comprises rapid heating and rapid cooling, e.g. fast thermocycling. The carrier (103) is typically a part of the rotary member of a spinner in the case the heating support is intended to be spinned as discussed above.

### Microdevices (101)

A microdevice is typically in the form of a plate (=disc) and encompasses a number of microcavities (102) in which liquid aliquots or droplets together with reactants and reagents are processed. Reactants and reagents include also an unknown to be determined (analyte). The number of microcavities per device is typically two, three or more, such as ≧10, such as ≧25 or ≧90 or ≧180 or ≧270. An upper limit may be 2000 or 3000.

The preferred disc-shaped variants typically has an axis of symmetry (Cₙ) (107) perpendicular to a disc plane where n is an integer 2, 3, 4, 5, 6 or more with preference for ≧10. Circular variants (n=∞) are included. Circular variants also include sector-shaped variants of circular variants and other variants that have an axis of symmetry perpendicular to a disc plane.

Static microdevices are variants in which the liquid aliquots are added to and processed within the microcavities without transport in a microchannel. The microcavities in static variants have typically been in the form of open wells, i.e. the device has been a micro titer plate, for instance. When static microdevices are used in the present invention, it should be secured that losses due to evaporation does not become significant, for instance by the use of a suitable cover during a process step performed at an elevated temperature.

Microfluidic devices belong to a variant in which liquid aliquots used in a protocol are dispensed to one or more inlet ports of a microchannel structure to be used and are then transported and processed in substructures that are present at predetermined positions in the microchannel structure. Typical substructures are inlet ports, reaction microcavities, mixing microcavities, detection microcavities (often transparent or opening to ambient atmosphere), outlet ports etc. Inlet and outlet ports are used for the introduction or exit of liquids and/or for inlet of or outlet to ambient atmosphere (vents).

The microcavities (102) to be heated can be designed as known in the field. For spinnable microfluidic devices it is preferred to equip the microcavity with an inwardly directed microconduit that is non-heated. The inwardly directed microconduit is typically in direct or indirect communication with ambient atmosphere. During heating liquid in the microcavity will partially evaporate and condense in this microconduit. Spinning will cause the condensate to be retransported out into the heated microcavity. See for instance WO 0146465 (Gyros AB), WO 0241997 (Gyros AB) and WO 0241998 (Gyros AB).

The microfluidic devices are well known in the field. See for instance discussion about background technology/publications in WO 02074438 (Gyros AB).

Microdevices that can be spinned are of particular interest. The main reason is that spinning is a very efficient way of cooling a heated microdevice while at the same time obtaining an extremely low temperature variation between heated microcavities that are at the same radial distance from the spin axis. Compare what has been said above with respect to heating supports that are spinned. For microfluidic devices there are additional advantages. If the device for instance comprises a microchannel structure that has a substructure extending from an upstream inner part to a downstream outer part, liquid flow can be driven between the parts by spinning the device around the spin axis. In this context “inner” and “outer” mean that the inner part is closer to the spin axis than the outer part. Variants in which the spin axis coincides with the axis of symmetry are described in WO 9721090 (Gamera Bioscience), WO 9807019 (Gamera Bioscience) WO 9853311 (Gamera Bioscience), WO 9955827 (Gyros AB), WO 9958245 (Gyros AB), WO 0025921 (Gyros AB), WO 0040750 (Gyros AB), WO 0056808 (Gyros AB), WO 0062042 (Gyros AB), WO 0102737 (Gyros AB), WO 0146465 (Gyros AB), WO 0147637, (Gyros AB), WO 0154810 (Gyros AB), WO 0147638 (Gyros AB), WO 02074438 (Gyros AB), WO 02075312 (Gyros AB), WO 02075775 (Gyros AB), and WO 02075776 (Gyros AB), all of which hereby are incorporated by reference. There are also variants in which there is no need for the spin axis to coincide with the axis of symmetry.

The number (plurality) of microchannel structures or microcavities on a microdevice comprises typically ≧10, such as ≧25 or ≧90 or ≧180 or ≧270. An upper limit may be 2000 or 3000.

Circular devices and other microdevices that can be used in the invention have a size that is in the interval 1% up to 5000% of the size of a conventional CD. The size and/or shape of a conventional CD are preferred.

The microcavities and the liquid aliquots to be heated are typically in the μl-format, with preference for the nl-format. The μl-format is ≦1000 μl, such as ≦100 μl or ≦110 μl or ≦10 μl. The nl-format is ≦5000 nl with preference for ≦1000 nl, such as ≦100 nl or ≦10 nl. The microchannel structures, if the microdevice is a microfluidic device, are in the microformat by which is meant that each of them have at least one cross-sectional dimension that is ≦10³ or ≦10² or ≦10¹ μm.

The bulk material in a microdevice may be organic or inorganic. Suitable organic materials include various types of plastics. Suitable inorganic materials include silicon, quartz and the like. The preferred materials are organic, such as organic polymers in the form of plastics. The bulk material in the microdevice should have been selected with a thermal conductivity in the range 0.05-5000 Joule/kg×° K., such as 0.5-4000 Joule/kg×° K. It is important to select material that is not deformed while heated to the desired temperature that typically is below 95° C. at the microcavity to be heated and typically below a slightly higher temperature at the contact surface S_{dev} of the microdevice (e.g. ≦120° C. such as ≦110° C. or ≦100° C.). Suitable plastic material should have softening temperature that are above this limits with at least 5° C., 10° C., 20° C. or more. Plastics based on fluorinated monomers, in particular of the alkene type, complying with these general guidlines are good candidates. Suitable thermal properties are many times found in bulk material having a selected density within the range of ≧0.9×10³ kg/m³, such as ≧103 kg/m³ and/or ≦2.5×10³ kg/m³, such as ≦1.4×10³ kg/m³.

A suitable microfluidic device may be manufactured by first providing a substrate which on one side has a surface with a plurality of uncovered microchannel structures and then in a subsequent step cover these structures with a second substrate (top or lid). See WO 9116966 (Pharmacia Biotech AB) and WO 0154810 (Gyros AB) and publications cited in either of these two publications. At least one of the substrates may comprise a plastic material, e.g. a polymeric material. The uncovered structures in the first substrate are preferably made by replication in a plastic material from a master matrix comprising the inverse of the uncovered microchannel structures.

### Cooling Means

In preferred variants the innovative arrangement also comprises means for cooling a heated microcavity, other heated parts of the microdevice and the heated parts of the heating support. The preferred cooling means comprises incorporating a generator for creating an air stream to pass over the free surfaces of the heating support and/or the free surfaces of the microdevice. This in principle means that the air stream should pass over the heating support (104) on the side that is opposite to the side comprising Sₛᵤₚ (110) and/or over the heating support on the side that is opposite to the side comprising S_{dev} (109). Cooling means also comprises that the contact side (111), in particular the support surface Sₛᵤₚ (110), has projections onto which the microdevice is retained with a possibility for air cooling between the heating support and a microdevice placed on the projections. The generator for creating a suitable air stream typically a stream of compressed cooling air or sucking cooling air over the surfaces of the heating support and/or the microdevice as indicated in the previous paragraph. This kind of air streams may be created by spinning the heating support loaded with the microdevice comprising the microcavities to be cooled, by directing a fan towards the appropriate surfaces of the arrangement, etc. A more complicated way is to incorporate cooling means in the form conduits for a cooling fluid, e.g. a liquid or a gas, within the heating support.

### Method Aspects of the Invention

These aspects of the invention comprises performing heating and process protocols as previously done but by using the inventive arrangement for heating and/or cooling steps (if present) including thermocycling.

### Process Protocols

The process protocols concerned typically have an analytical, preparative or synthetic purpose. The field typically is natural science, such as biological or chemical science, and includes medicine, diagnostics, zoology, chemistry, biochemistry, organic chemistry, inorganic chemistry, analytical chemistry, molecular biology, microbiology, occupational health, environmental studies etc.

A process protocol to be used in the innovative arrangement comprises at least one step carried out at an elevated temperature. This at least one step may be selected amongst performing mixing of two or more liquids, reaction between one, two or more reactants, a separation to separate one or more desired or undesired components from a bulk liquid, detection of the result of a protocol, a reaction, a mixing, a separation etc.

The term “elevated temperature” for a particular step means that the step is carried out at a temperature that is above ambient temperature, i.e. above the temperature of the environment of the microdevice. The temperature of a particular microcavity of a microdevice may vary for different steps of a particular protocol. The temperature variation may be cyclic in which case the process protocol is thermocyclic. The simplest thermocyclic protocol comprises only one cycle, i.e. the temperature is first raised for one or more steps (high temp steps) and then lowered for one or more subsequent steps (low temp steps). A typical thermocycling protocol comprises two or more cycles, which normally means that the same reactions or treatments are repeated twice, thrice etc often with the main difference that the product of a preceding cycle is the starting substrate for a subsequent cycle and with corresponding reagents for different cycles being the same and/or analogues.

Typical reactions to be carried out in the heated microcavity of a microdevice are selected amongst enzymatic reactions, affinity reactions etc. The reactions may be homogeneous or heterogeneous including affinity adsorption to a solid phase contained in the microcavity or reaction of one or more solid-phase bound members of an enzymatic system with one or more soluble members of the same system etc. A number of reactions may be carried out in sequence, possibly with some other kind of steps in between, such as a separation, a washing and/or a detection step. A protocol may comprise a sequence of steps such as one or more enzyme related steps, for instance between an enzyme and its substrate, one or more affinity reactions between affinity counterparts etc. A protocol may comprise one or more steps that involve a homogeneous reaction and/or one or more steps that involve a heterogeneous reaction between a solid phase bound reactant and a soluble reactant and/or one or more steps that comprise both heterogeneous and homogeneous reactions. Different steps may be carried out in different parts of a microchannel structure, for instance in different microcavities where at least one of the microcavities is heated in accordance with the invention.

### Experimental Part

Heating experiments was simulated for the arrangement illustrated in FIGS. 1-3 except that the microdevice (101) was a dummy one without the indicated microcavity (102). The rotary member (carrier) (103) of a spinner (only indicated as its rotary member) carried a circular heating support (104,204) to which a microfluidic device (101) was retained by sub pressure. The spin axis (105) defined by the spinner coincides with the axes of symmetry (106,206 and 107) of the heating support (104,204) and the microdevice (101), respectively. The microdevice (101) has one side (109, contact side) providing a device contact surface S_{dev} (108) that is adapted to be placed in contact with the support contact surface Sₛᵤₚ (110) on the contact side (111) of the heating support (104,204). A microcavity (102) to be heated is indicated in the microdevice (101). The microcavity (102) is covered by a lid (112). Sub pressure was linked to the rotary member (103) from a sub pressure source (113) via external tubings (114), a subpressure swivel (115) on the rotary member (103), a conduit system (116) in the rotary member (103), and a channel system (117,217) in the heating support (104,204) to radial and annular grooves (118,218 and 119,219 respectively) in the contact surface Sₛᵤₚ (110) of the heating support (104,204). The grooves (118,218 and 119,219) were covered by the microdevice (101) placed on the support surface Sₛᵤₚ (110). The heating support (103) contains five annular electrical heating elements (120a-e,220a-e) placed in annular depressions (121a-e) that via wires (122) and an annular contact (123) on the rotary member (103) are connected to an electrical swivel (124). This swivel is in turn connected to a voltage source (not shown).

The microdevice (101) contains one thermal contact area (125) for each microcavity (102) to be heated. This thermal contact area (125) is defined as the volume covered by a microcavity (102) and located between the microcavity (202) and the contact surface S_{dev} (108) of the microdevice (101). Similarly the heating support (104) contains one thermal contact area (126) for each microcavity (102) to be heated of a microdevice (101). This thermal contact area (126) is defined as the part volume in the heating support (104) that is covered by a microcavity (102) that is juxta-positioned over the heating elements (120) by properly orienting the microdevice (101). The thermal contact area (126) of the heating support extends from the support contact surface Sₛᵤₚ (110) to a heating element (120).

The heating support (104) is adapted to patterned heating which is apparent from the fact that the microcavity (102) covers a part (127) of the heating support that is between two heating elements and a part (128) that is above a heating element

FIG. 1 also shows that the microcavity (102) may be connected to an inwardly directed microconduit (138) that preferably directly or indirectly communicates with ambient atmosphere. During heating while spinning the heating support (104) with microdevice (101) this microconduit (138) will act as a condenser effectively preventing over pressure with risks for explosions and/or loss of liquid due to evaporation.

Both the heating support (104) and the microdevice (101) are made of plastics and have a diameter of 60 mm and a thickness of 1.2 mm each. The heating elements (117) are placed between 40-50 mm from the centre.

FIG. 2 illustrates a circular heating support (204) from below with radial and annular sub pressure grooves (218,219, respectively) on the support contact surface Sₛᵤₚ (210) that in this variant coincides with the contact side (211). Close to the circumference (229) and outside the part surface carrying the sub pressure grooves (218,219) there is a smooth annular zone (230) that assists in obtaining air-tight sealing between the support surface Sₛᵤₚ (210) and the contact side S_{dev} (209) of a microdevice (101). This annular zone (230, i.e. 130 in FIG. 1) may also contain an annular sealing element (not shown), preferably resilient, placed in an annular groove (not shown) that is not part of the sub pressure system. On the side that is opposite to the support surface Sₛᵤₚ there are electrical annular heating elements (220) with wires to be connected to the el-swivel (124) on the rotary member (103) shown in FIG. 1a. FIG. 2 also indicates the presence of a channel system (217) for sub pressure communication between the conduit system (116) in the carrier (103, =rotary member) and the sub pressure grooves (218,219) in the heating support (204). The axis of symmetry (206) and a suitable spin axis (205) pass through the centre of the support (204).

FIG. 3 shows that an even temperature could be obtained in an annular zone of a top layer of a circular microdevice placed on a circular heating support. Half of the heating support (from its centre to its circumference) is between line (332) and line (333). Half of the microdevice (from its centre to its circumference) is between line (332) and line (334). The line (332) represents that Sₛᵤₚ and S_{dev} are in contact with each other. The Y-axis gives distances in meters from the lower side of the heating support and the x-axis distances in meters from the centre of the microdevice/heating support. The vertical line (335) corresponds to the centre of the microdevice/heating support. There are five annular heating elements (320a,b . . . ) as in the heating support shown in FIGS. 1-2. The irregular lines (336a,b,c . . . ) are isotherms where the outermost isotherm represents around +70° C. and the innermost isotherms +130° C. or more. The isotherms show that there is a local area with an elevated temperature and an insignificant temperature gradient in the microdevice at position where a microcavity normally is located, i.e. at the surface of the microdevice that is straight opposite to the location of the heating elements.

Certain innovative aspects of the invention are defined in more detail in the appending claims. Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A heating arrangement for heating one or more liquid-containing microcavities that are present on a microdevice which comprises a device contact surface (S_{dev}), which arrangement comprises a heating support having
a) a support contact surface (Sₛᵤₚ) which is apposed to, when the microdevice is placed on the heating support, and
b) one or more heating elements each of which are in thermal contact with Sₛᵤₚ, and also with at least one of said microcavities, when the microdevice is placed according to (a) with said microcavities matched to said heating elements,
wherein the arrangement comprises a sub pressure system that is capable of creating sub pressure between said support and said microdevice via the support when the microdevice is placed on the support.

2. The heating arrangement of claim 1, wherein said sub pressure system comprises one or more recessed parts in Sₛᵤₚ.

3. The heating arrangement of claim 2, wherein said recessed parts comprise straight grooves and/or annular or arc-shaped grooves.

4. The heating arrangement of claim 2, wherein said recessed parts defines a spike arrangement.

5. The heating arrangement of claim 2, wherein said recessed parts and said sub pressure system is capable of accomplishing essentially equal retaining force between S_{dev} and Sₛᵤₚ at each of said microcavities when said microdevice is placed on said support according to a) and b).

6. The heating arrangement of claim 1, wherein said sub pressure system comprises a sub pressure source that is capable of creating a sub pressure between the support and the microdevice capable of retaining said microdevice to said support during heating of said one or more microcavities.

7. The heating arrangement of claim 1, wherein the Sₛᵤₚ comprises a sealing element encircling recessed parts of the sub pressure system.

8. The heating arrangement of claim 1, wherein said microdevice is part of the arrangement with S_{dev} apposed to Sₛᵤₚ and with the microcavities juxta-positioned over the heating elements thereby defining for each microcavity to be heated
a) a device thermal contact area as the volume of the microdevice covered by and located between a microcavity and S_{dev}, and
b) a support thermal contact area as the volume of the heating support covered by a device thermal contact area/microcavity and located between Sₛᵤₚ down to the level of a heating element.

9. The heating arrangement of claim 1, wherein the microdevice is a microfluidic device.

10. The heating arrangement of claim 8, wherein said one or more recessed parts of the sub pressure system are essentially outside the support thermal contact areas.

11. The heating arrangement of claim 1, wherein the bulk of the microdevice is made of a material that is selected from materials having a thermal conductivity selected in the range 0.05-5000 Joule/kg×K.

12. The heating arrangement of claim 11, wherein said material has been selected amongst materials that have a density in the interval of 10³-2.5×10³ kg/m³.

13. The heating arrangement of claim 1, wherein said one or more of the heating elements are present in Sₛᵤₚ or within the heating support, preferably at a distance from Sₛᵤₚ that is larger than the depth of the recessed parts, if present.

14. The heating arrangement of claim 1, wherein said one or more of the heating elements are present on the surface of the side that is opposite to Sₛᵤₚ.

15. The heating arrangement of claim 1, wherein said support is in the form of a plate that has a thickness from Sₛᵤₚ selected within the interval 0.1-10 mm.

16. The heating arrangement of claim 2, wherein said support is in the form of a plate that has a thickness (t) from Sₛᵤₚ with a maximum value in the interval 2×d<t<1000×d where d is the depth of the deepest one of the recessed parts.

17. The heating arrangement of claim 1, wherein said each heating element is based on accomplishing an increase in temperature of the elements by
(a) irradiating the elements,
(b) carrying out an exothermal chemical reaction within the elements,
(c) transporting current through the elements,
(d) contacting the elements with an external heat source,
(e) through flow of thermostatted liquid, such as water,
(f) etc.

18. The heating arrangement of claim 1, wherein each heating element comprises a conducting material of a high resistivity which via a conducting material of low resistivity within or on the support is connected to an external voltage source.

19. The heating arrangement of claim 1, further comprising a generator for creating an air stream across
(a) the surface of the side of the support that is opposite to Sₛᵤₚ and/or
(b) the surface of the side of the microdevice that is opposite to S_{dev}.

20. The heating arrangement of claim 19, wherein the generator comprises a spinner that is capable of spinning the heating support and the microdevice placed on the heating support, and/or comprises a fan.

21. The heating arrangement claim 1, wherein the arrangement comprises a spinner for spinning the heating support with a microdevice retained on the heating support.

22. The heating arrangement of claim 1 wherein the microdevice and the heating support is designed to be spun about a spin axis and that each microcavity to be heated is directly linked to a microconduit that at its start at the microcavity is directed towards a shorter radial distance than the radial distance of the microcavity.
